(19) United States
(12) Patent Application Publication
(10) Pub. No.: US 2009/0070523 A1
(43) Pub. Date: Mar. 12, 2009

(54) Flash memory device storing data with multi-bit and single-bit forms and programming method thereof

(76) Inventors: Hyung-Min Kim, Suwon-si (KR); Ho-Kil Lee, Yongin-si (KR); Eun-Kyoung Kim, Hwaseong-si (KR)

Correspondence Address: LEE & MORSE, P.C., 3141 FAIRVIEW PARK DRIVE, SUITE 500, FALLS CHURCH, VA, 22042, US

(21) Appl. No.: 12/230,336

(22) Filed: Aug. 27, 2008

(30) Foreign Application Priority Data
Aug. 27, 2007 (KR) 10-2007-0086072

(51) Int. Cl. G06F 12/02; G06F 12/00

(52) U.S. Cl. 711/103; 711/E12.001; 711/E12.008

(57) ABSTRACT

A flash memory device may include a memory cell array including a plurality of memory blocks and a partition information block, the partition information block storing partition information that indicates a boundary between multi-bit memory blocks and single-bit memory blocks among the memory blocks. The memory device may include a control logic configured to determining whether a memory block that a block address from the outside indicates has a multi-bit form or a single-bit form based on the partition information and to control program and read operations in a multi-bit form or a single-bit form based on a determination result. The control logic automatically programs data in the partition information block according to whether a fuse connected to the control logic fuse is cut or not, the data being used for preventing the partition information block from being programmed or erased.

### BACKGROUND OF THE INVENTION

1. Field of the Invention

Embodiments relate to a semiconductor memory device and a programming method thereof. More particularly, embodiments are directed to a flash memory device storing data in a multi-bit and single-bit form and a programming method thereof.

2. Description of the Related Art

A semiconductor memory device is a memory device capable of programming data thereto and reading data therefrom. Semiconductor memory devices are largely classified into a random access memory (RAM) and a read only memory (ROM). The RAM is a volatile memory device that loses stored data when no power is applied. The ROM is a non-volatile memory device that retains stored data even when there is no power. The RAM includes dynamic RAM (DRAM) and static RAM (SRAM). The ROM includes a programmable ROM (PROM), an erasable PROM (EPROM), and an electrically EPROM (EEPROM), e.g., a flash memory device. Flash memory devices are generally divided into a NAND type and a NOR type. The NAND flash memory device has a higher integration than the NOR flash memory device.

As an amount of data to be processed increases due to the development of electronic devices, a memory device having a higher storage capacity is in demand. An example of a memory device capable of providing a higher storage capacity and a lower manufacturing cost is a multi-bit memory device. A single-bit memory device stores 1-bit data of ‘1’ or ‘0’ in one memory cell, and a multi-bit memory device stores 2-bit data of ‘11’, ‘10’, ‘00’, or ‘01’ in one memory cell. In the multi-bit memory device, one memory cell is programmed to have one of respectively different four threshold voltages. A threshold voltage of a memory cell is determined through respectively different three read voltages.

The multi-bit memory device provides more high storage capacity than the single-bit memory device. However, program and read speeds and reliability of the multi-bit memory device are lower than those of the single-bit memory device. Therefore, electronic devices may include both multi-bit memory devices and single-bit memory devices. In such cases, data requiring a high storage capacity are stored in the multi-bit memory device, and data requiring a high speed and reliability are stored in the single-bit memory device. However, when two memory devices are used, cost and size of electronic device increases. Accordingly, to reduce cost and size of electronic devices, a memory device with a multi-bit and single-bit form is required.

The memory device using the multi-bit and single-bit form simultaneously includes a program circuit and a read circuit of the multi-bit and single-bit form. Additionally, the memory device may include information (hereinafter, referred to as “partition information”) indicating the boundary between a multi-bit region and a single-bit region in a memory cell array.

One important feature in the memory device storing data in a multi-bit and single-bit form is preventing partition information, which indicates storage regions of a multi-bit and a single-bit, from being damaged. For example, assume that one memory block stores data with a multi-bit form. Since a multi-bit form and a single-bit form have respectively different program and read operations, if this memory block is set into a storage region of a single-bit due to a change in the partition information, pre-existing data stored in that memory block is damaged. Therefore, after setting a multi-bit region and a single-bit region, partition information should not be modified or erased.

### SUMMARY OF THE INVENTION

Embodiments are therefore directed to a semiconductor memory device and a programming method thereof, which substantially overcome one or more of the disadvantages of the related art.

An embodiment is therefore directed to providing a flash memory device capable of preventing partition information from being modified or erased, the partition information indicating the boundary between multi-bit and single-bit regions in a flash memory device that stores data in a multi-bit or a single-bit form.

An embodiment is therefore directed to providing a flash memory device automatically performing an operation that prevents partition information from being modified or erased.

At least one of the above and other advantages may be realized by providing flash memory devices including a memory cell array including a plurality of memory blocks and a partition information block, the partition information block being configured to store partition information that indicates a boundary between multi-bit memory blocks and single-bit memory blocks among the memory block, a control logic configured to determine whether a memory block that a block address from the outside indicates has a multi-bit form or a single-bit form based on the partition information and to control program and read operations in a multi-bit form or a single-bit form based on a determination result; and a fuse connected to the control logic, wherein the control logic is configured to automatically program data in the partition information block according to whether the fuse is cut or not, the data being used for preventing the partition information block from being programmed or erased.

In some embodiments, the control logic allows the partition information block to be programmable and erasable in response to an external control signal.

In other embodiments, the control logic prevents the partition information block from being erased according to whether the fuse is cut or not.

In still other embodiments, the control logic includes a multi-bit program controller and a single-bit program controller.

In even other embodiments, the control logic further includes a multi-bit read controller and a single-bit read controller.

In yet other embodiments, the control logic includes a register storing the partition information.

In further embodiments, the flash memory device is cold reset after the partition information block is programmed.

In still further embodiments, the partition information is loaded into the register after the partition information block is programmed.

In even further embodiments, the partition information block has the same structure as the memory block.

In yet further embodiments, the partition information block is a single-bit memory block.

In yet further embodiments, continuously arranged memory blocks adjacent to the partition information block are set as a single-bit memory block.

In yet further embodiments, the fuse is disposed in the control logic.

At least one of the above and other advantages may be realized by providing methods of programming a flash memory device including programming partition information in a partition information block, the partition information indicating a boundary between multi-bit memory blocks and single-bit memory blocks among the memory blocks; and automatically programming data in the partition information block according to whether a fuse is cut or not, the data being used for preventing the partition information block from being programmed or erased.

In some embodiments, erasing of the partition information block is prevented according to whether the fuse is cut or not.

In other embodiments, the programming of the data is selectively performed according to whether the fuse is cut or not.

At least one of the above and other advantages may be realized by providing memory systems including a flash memory device; and a memory controller controlling the flash memory device, wherein the flash memory device may be in accordance with any of the embodiment described above.

In some embodiments, the flash memory device and the memory controller constitute a memory card.

### BRIEF DESCRIPTION OF THE DRAWINGS

The above and other features and advantages will become more apparent to those of ordinary skill in the art by describing in detail exemplary embodiments thereof with reference to the attached drawings, in which:

FIG. 1 illustrates a block diagram of a flash memory device storing data with a multi-bit and single-bit form according to an embodiment of the present invention;

FIG. 2 illustrates a block diagram of a control logic of FIG. 1 according to an embodiment of the present invention;

FIG. 3 illustrates a block diagram of a flash memory where a fuse is added to the flash memory device of FIG. 1 according to an embodiment of the present invention;

FIG. 4 illustrates a block diagram of a control logic of FIG. 3 according to an embodiment of the present invention;

FIG. 5 illustrates a flowchart of a process of programming a locking-bit in the flash memory device of FIG. 3 according to an embodiment of the present invention;

FIG. 6 illustrates a flowchart of performing of an erase operation on a partition information block in the flash memory device of FIG. 3 according to an embodiment of the present invention;

FIG. 7 illustrates a block diagram of a memory card including a flash memory device according to an embodiment of the present invention; and

FIG. 8 illustrates a block diagram of a memory system with a flash memory device according to an embodiment of the present invention.

### DETAILED DESCRIPTION OF THE INVENTION

Korean Patent Application No. 10-2007-0086072, filed on Aug. 27, 2007, in the Korean Intellectual Property Office, and entitled: “Flash Memory Device Storing Data with Multi-Bit and Single-Bit Form and Programming Method Thereof,” is incorporated by reference herein in its entirety.

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the invention to those skilled in the art.

To accurately and precisely describe the present invention, general operations for programming data in a memory cell array and erasing data stored in the memory cell array are respectively called a general program operation and a general erase operation, respectively, within a flash memory device.

Example embodiments provide a flash memory device preventing a partition information block from being programmed or erased during a program or erase operation of a memory cell array by using a locking-bit, and preventing a partition information block from being erased in a partition information block access mode by using a partition information fuse. Additionally, embodiments may include a flash memory device providing a mode where a user directly programs a locking-bit and a mode where a locking-bit is automatically programmed.

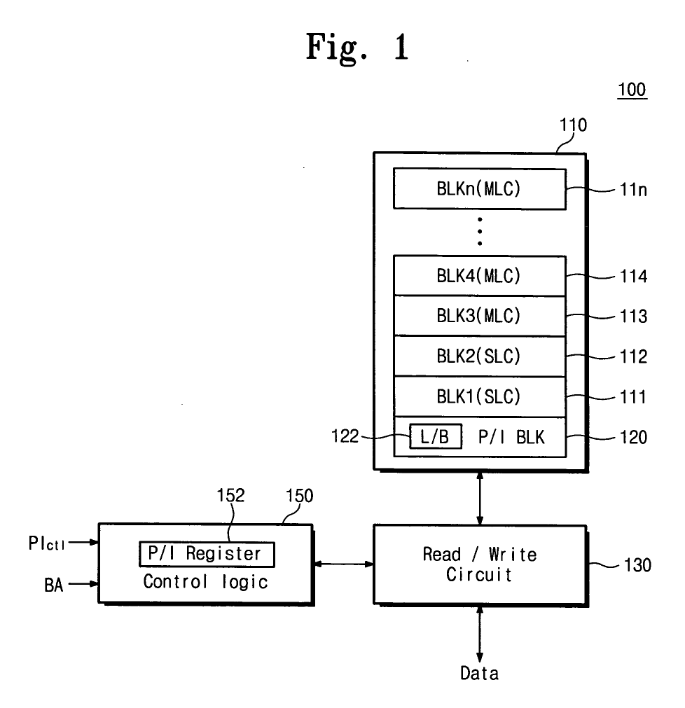

FIG. 1 illustrates a block diagram of a flash memory device 100 storing data with a multi-bit and single-bit form according to an embodiment of the present invention. Referring to FIG. 1, the flash memory device 100 may include a memory cell array 110, a read/write circuit 130, and a control logic 150.

The memory cell array 110 may include a plurality of memory blocks 111 to 11n and a partition information block 120. Referring to FIG. 1, the flash memory device 100 may include the n number of memory blocks. In each memory block, data may be stored with one of a multi-bit form and a single-bit form. Each storage region may be divided by a memory block unit. Hereinafter, memory blocks storing data with a multi-bit form are called multi-bit memory blocks 113 to 11n and memory blocks storing data with a single-bit form are called single-bit memory blocks 111 and 112.

The partition information block 120 may include partition information PI of the memory blocks 111 to 11n and a locking-bit 122. The partition information PI may represent a boundary between a region storing data with a multi-bit form and a region storing data with a single-bit form in the memory cell array 110. The locking-bit 122 may prevent the partition information block 120 from being programmed or erased during a general program or erase operation. For example, 14^{th} and 15^{th} bits in a first word of a first sector in the partition information block 120 may be set with a locking-bit 122. The locking-bit 122 having a ‘00’ state represents that the locking-bit 122 is programmed.

Because the partition information block 120 stores the partition information PI indicating a state of each memory blocks 111 to 11n in the memory cell array 110, a single-bit, which is more stable than a multi-bit, may be used to store the partition information PI. Continuously arranged memory blocks adjacent to the partition information block 120 may be set as single-bit memory blocks 111 and 112. The reason is that if single-bit memory blocks including the partition information block 120 are continuously arranged, the number of boundaries between a multi-bit and single-bit memory blocks is minimized. Therefore, the size of the partition information PI may be reduced.

The read/write circuit 130 may write data in the memory cell array 110 and read data from the memory cell array 110 in response to the control logic 150. Although not illustrated in the drawings, it may be understood to those skilled in the art that the read/write circuit 130 may include a row decoder, a column selector, a page buffer, and a pass/fail circuit.

According to the partition information PI, the control logic 150 may determine whether a memory block that a block address BA receives from outside represents a multi-bit memory block or a single-bit memory block. If the memory block that the block address BA represents is one of multi-bit memory blocks 113 to 11n, the control logic 150 may control the read/write circuit 130 to perform a read/write operation on the multi-bit memory block. If the memory block that the block address BA represents is one of the single-bit memory blocks 111 to 112, the control logic 150 may control the read/write circuit 130 to perform a read/write operation on the single-bit memory block.

If the memory block that the block address BA represents is the partition information block 120, the control logic 150 may refer to the locking-bit 122. If the locking-bit 122 is programmed, the control logic 150 may prohibit program and erase operations of the partition information block 120. If the locking-bit 122 is not programmed, the control logic 150 may permit program and erase operations of the partition information block 120.

Once an external control signal PIctl is delivered, the control logic 150 may perform program and erase operations on the partition information block 120 regardless of whether the locking-bit 122 is programmed or not. Hereinafter, a programmable and erasable state of the partition information block 120 in response to the external control signal PIctl is called a partition information access mode.

The control logic 150 may include a partition information register 152. The partition information PI and data of the locking-bit 122 stored in the partition information block 120 may be loaded into the partition information register 152. When the flash memory device 100 is in a power-on-reset state, the partition information PI and the data of the locking-bit 122 may be loaded into the partition information register 152. Accordingly, when the block address BA is delivered from the outside, the control logic 150 may refer to the partition information register 152 instead of reading the partition information PI and the data of the locking-bit 122 from the partition information block 120.

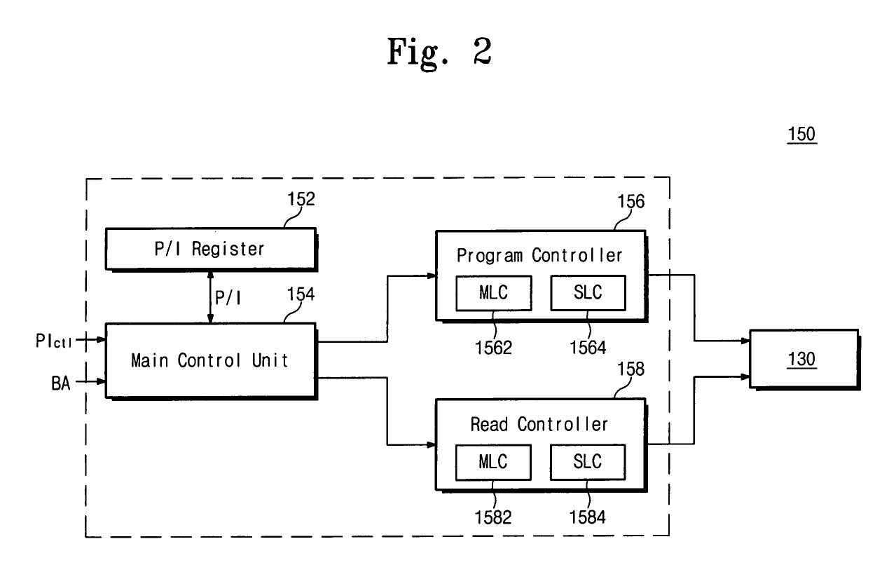

FIG. 2 illustrates a block diagram of the control logic 150 of FIG. 1 according to an embodiment. Referring to FIG. 2, the control logic 150 may include the partition information register 152, a main control unit 154, a program controller 156, and a read controller 158. Because the partition information register 152 is described with reference to FIG. 1, it has the same reference number and its detailed description will not be repeated for conciseness.

The main control unit 154 may control each component of the control logic 150. The main control unit 154 may control the control logic 150 and the read/write circuit 130 to allow the partition information PI stored in the partition information block 120 of FIG. 1 and data of the locking-bit 122 to be loaded into the partition information register 152 during a power-on-reset operation. Once the block address BA is delivered from the outside, the main control unit 154 may determine whether the memory block that the block address BA represents is a multi-bit memory block or a single-bit memory block based on the partition information PI stored in the partition information register 152. According to a determination result, the main control unit 154 may control the program controller 156 to perform a program operation in a multi-bit or a single-bit and may control the read controller 158 to perform a read operation in a multi-bit or a single-bit.

If the block address BA represents the partition information block 120 of FIG. 1, the main control unit 154 may refer to the data of the locking-bit 122 of FIG. 1 stored in the partition information register 152. If the locking-bit is programmed, the main control unit 154 may prevent the partition information block 120 from being programmed or erased. When the external control signal PIctl is delivered, the main control unit 154 may perform a partition information access mode.

The program controller 156 may control the read/write circuit 130 to perform a program operation on a multi-bit memory block or a single-bit memory block in response to the main control unit 154. The program controller 156 may include a multi-bit program controller 1562 and a single-bit program controller 1564. When a program operation is performed on the multi-bit memory block 113 to 11n of FIG. 1, the multi-bit program controller 1562 may control the read/write circuit 130. On the other hand, when a program operation is performed on the single-bit memory block 111 and 112 of FIG. 1, the single-bit program controller 1564 may control the read/write circuit 130.

The read controller 158 may control the read/write circuit 130 to perform a read operation on a multi-bit memory block or a single-bit memory block in response to the main control unit 154. The read controller 158 may include a multi-bit read controller 1582 and a single-bit read controller 1584. When a read operation is performed on the multi-bit memory block 113 to 11n of FIG. 1, the multi-bit read controller 1582 may control the read/write circuit 130. On the other hand, when a read operation is performed on the single-bit memory block 111 to 112 of FIG. 1, the single-bit read controller 1584 may control the read/write circuit 130.

Hereinafter, referring to FIGS. 1 and 2, a method of preventing the partition information PI and the data of the locking-bit 122 from being programmed into the partition information block 120 and preventing a program or erase operation on the partition information block 120 in the flash memory device 100 in accordance with an embodiment of the present invention will be described.

Once power is applied, a power-on-reset operation may be performed. At this point, the partition information PI stored in the partition information block 120 and the data of the locking-bit 122 may be loaded into the partition information register 152. Once the block address BA is delivered, the control logic 150 may refer to the partition information PI stored in the partition information register 152. When the block address BA represents a multi-bit memory block or a single-bit memory block, the control logic 150 may perform a program or erase operation on a corresponding memory block. If the block address BA represents the partition information block 120, the control logic 150 may refer to the data of the locking-bit 122 stored in the partition information register 152. If the locking-bit 122 is not programmed, the partition information block 120 may be programmed or erased according to general program and erase operations. That is, the partition information PI may arbitrarily vary and the locking-bit 122 may be arbitrarily programmed. If the locking-bit 122 is programmed, the control logic 150 may prevent the partition information block 120 from being programmed or erased.

Once the external control signal PIctl is delivered, the control logic 150 may perform a partition information access mode. That is, regardless of whether the locking-bit 122 is programmed or not, the partition information block 120 may be programmed or erased. Thus, the partition information PI may arbitrarily vary and the locking-bit 122 may be arbitrarily programmed.

In other words, in the flash memory device 100 of FIG. 1, the partition information PI may be modified or erased in two cases. First, if the locking-bit 122 is not programmed, the partition information PI may be modified and erased through general program and erase operations. Second, if the locking-bit 122 is programmed and if the partition information access mode is performed in response to the external control signal PIctl, the partition information PI may be modified and erased. If the partition information PI is modified and erased when data are stored in the memory blocks 111 to 11n, the multi-bit memory blocks 113 to 11n storing data may be recognized as the single-bit memory block of a single-bit 111 and 112. Otherwise, the single-bit memory blocks 111 and 112 may be recognized as the multi-bit memory blocks 113 to 11n. In this case, data stored in the multi-bit memory blocks 111 to 11n may not be properly read by the read/write circuit 130.

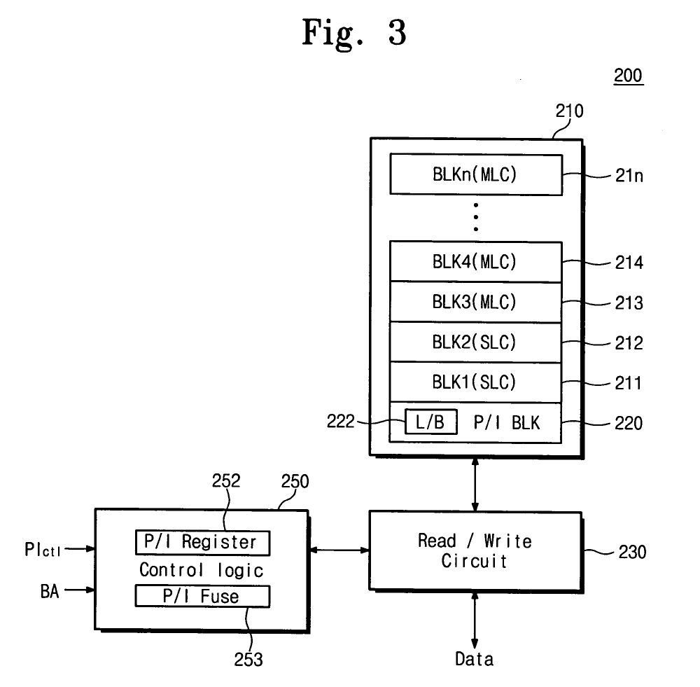

FIG. 3 illustrates a block diagram of a flash memory 200 where a fuse is added to the flash memory device of FIG. 1. Referring to FIG. 3, the flash memory device 200 in accordance with an embodiment of the present invention may include a memory cell array 210, a read/write circuit 230, and a control logic 250. Structure and functioning of the memory cell array 210 and the read/write circuit 230 may be identical to those of the memory cell array 110 and the read/write circuit 130 of FIG. 1. Accordingly, overlapping description may not be repeated for conciseness.

The control logic 250 of an embodiment may determine whether a memory block that a block address BA input from outside represents is a multi-bit memory block or a single-bit memory block based on the partition information PI. If the memory block that the block address BA represents is a multi-bit memory block 213 to 21n, the control logic 250 may control the read/write circuit 230 to perform read/write operations in a multi-bit form. If the memory block that the block address BA represents is a single-bit memory block 211 to 212, the control logic 250 may control the read/write circuit 230 to perform read/write operations in a single-bit form.

If the memory block that the block address BA represents is a partition information block 220, the control logic 250 may refer to a locking-bit 222. If the locking-bit 222 is programmed, the control logic 250 may prohibit program and erase operations of the partition information block 220. If the locking-bit 222 is not programmed, the control logic 250 may permit program and erase operations of the partition information block 220.

Once an external control signal PIctl is delivered, the control logic 250 may perform a partition information access mode. Additionally, the control logic 250 may determine whether a partition information fuse 253 is cut or not. According to a determination result, it is determined whether or not an erase operation is performed on the partition information block 220. For example, if the partition information fuse 253 is in a short state, the control logic 250 may perform a program or erase operation on the partition information block 220. That is, the same partition information access mode as that of the flash memory device 100 of FIG. 1 may be performed. On the contrary, if the partition information fuse 253 is cut off, the control logic 250 may permit a program operation on the partition information block 220 and may prevent an erase operation. Furthermore, once the partition information PI is programmed, the control logic 250 may automatically program the locking-bit 222. That is, once the partition information PI is input by a user when the partition information fuse 253 is cut off, the locking-bit 222 may be automatically programmed and the partition information block 220 may be automatically locked. Moreover, in the partition information access mode, the erasing of the partition information block 220 may be prevented.

The control logic 250 may include a partition information register 252 and a partition information fuse 253. The partition information PI and data of the locking-bit 222 stored in the partition information block 220 may be loaded into the partition information register 252. The partition information PI and the data of the locking-bit 222 may be loaded into the partition information register 252 when the flash memory device 200 is in a power-on-reset state. Accordingly, when the block address BA is delivered from the outside, the control logic 250 may refer to the partition information register 252 instead of reading the partition information PI and the data of the locking-bit 222 from the partition information block 220. In the partition information access mode, the partition information fuse 253 may be a reference determining whether an erase operation can be performed on the partition information block 220 or not.

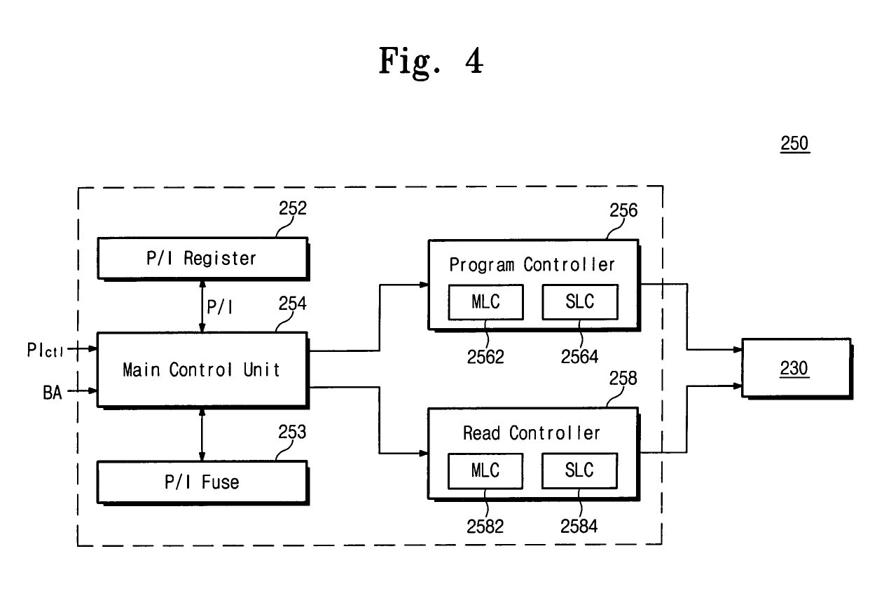

FIG. 4 illustrates a block diagram of the control logic 250 of FIG. 3 according to an embodiment. Referring to FIG. 4, the control logic 250 may include the partition information register 252, the partition information fuse 253, a main control unit 254, a program controller 256, and a read controller 258. Structure and functioning of the partition information register 252, the program controller 256, and the read controller 258 may be identical to those of the partition information register 152, the program controller 156, and the read controller 158 of FIG. 2. Accordingly, overlapping description may not be repeated for conciseness.

The main control unit 254 may control each component of the control logic 250. The main control unit 254 may control the control logic 250 and the read/write circuit 230 to allow the partition information PI stored in the partition information block 220 of FIG. 3 and data of the locking-bit 222 to be loaded into the partition information register 252 during a power-on-reset operation. Once the block address BA is received, the main control unit 254 may determine whether the memory block that the block address BA represents is one of multi-bit memory blocks 213 to 21n or one of single-bit memory blocks 211 and 212 according to the partition information PI stored in the partition information register 252. According to a determination result, the main control unit 254 may control a program controller 256 to perform a program operation on a multi-bit memory block or a single-bit memory block, and may control the read controller 258 to perform a read operation on a multi-bit memory cell or a single-bit memory cell.

If the block address BA represents the partition information block 220 of FIG. 3, the main control unit 254 may refer to the data of the locking-bit 222 of FIG. 3 stored in the partition information register 252. If the locking-bit 222 is programmed, the main control unit 254 may prevent the partition information block 220 from being programmed or erased. When the external control signal PIctl is delivered, the main control unit 254 may refer to a state of the partition information fuse 253. If the partition information fuse 253 is in a short state, the main control unit 254 may perform a partition information access mode where the partition information block 220 may be programmed or erased. If the partition information fuse 253 is cut off, the main control unit 254 may perform a partition information access mode in which the partition information block 220 is programmable, but not erasable. Additionally, once the partition information PI is input, the main control unit 254 may automatically program the locking-bit 222 of FIG. 3. For example, the main control unit 254 may control the program controller 256 to allow the locking-bit 222 of the partition information block 220 to be programmed with ‘00’.

Hereinafter, referring to FIGS. 3 and 4, a method of preventing the partition information PI and the data of the locking-bit 222 from being programmed into the partition information block 220 and of preventing a program or erase operation on the partition information block 220 in the flash memory device 200 in accordance with an embodiment of the present invention will be described.

Once power is applied, a power-on-reset operation is performed. At this point, the partition information PI and the data of the locking-bit 222 stored in the partition information block 220 may be loaded into the partition information register 252. Once the block address BA is delivered, the control logic 250 may refer to the partition information PI stored in the partition information register 252. When the block address BA represents a multi-bit memory block or a single-bit memory block, the control logic 250 may perform a program or erase operation on a corresponding memory block. If the block address BA represents the partition information block 220, the control logic 250 may refer to the data of the locking-bit 222 stored in the partition information register 252. If the locking-bit 122 is not programmed, the partition information block 220 may be programmed or erased according to general program and erase operations. That is, the partition information PI may arbitrarily vary and the locking-bit 122 may be arbitrarily programmed. If the locking-bit 222 is programmed, the control logic 250 may prevent the partition information block 220 from being programmed or erased.

Once the external control signal PIctl is delivered, the control logic 250 may determine a state of the partition information fuse 253. If the partition information fuse 253 is in a short state, the control logic 250 may perform a partition information access mode in which the partition information block 220 may be programmed and erased. If the partition information fuse 253 is cut off, the control logic 250 may perform a partition information access mode in which the partition information block is programmable, but not erasable. Additionally, if the partition information PI is programmed, the control logic 250 may automatically program the locking-bit 222. That is, once the partition information PI is programmed, the control logic 250 may automatically lock the partition information block 220. The erasing of the partition information block 220 may be prevented in the partition information access mode.

In other words, the flash memory device 200 of FIG. 3 may provide three modes. In a first mode, the partition information fuse 253 is in a short state and the locking-bit 222 is not programmed. In this first mode, the partition information block 220 may be arbitrarily programmed or erased through general program and erase operations. In a second mode, the partition information fuse 253 is in a short state and the locking-bit 222 is programmed. In this second mode, the partition information block 220 may not be programmed or erased through general program and erase operations. However, in this second mode, which is the partition information access mode, the partition information block 220 may be arbitrarily programmed or erased. In a third mode, the partition information fuse 253 is cut off. In this third mode, once the partition information PI is programmed, the locking-bit 222 may be automatically programmed. Additionally, erasing of the partition information block 220 may be prevented even in the partition information access mode. That is, the partition information fuse 253 may enhance the stability of the partition information PI and may make the locking of the partition information block 220 more convenient.

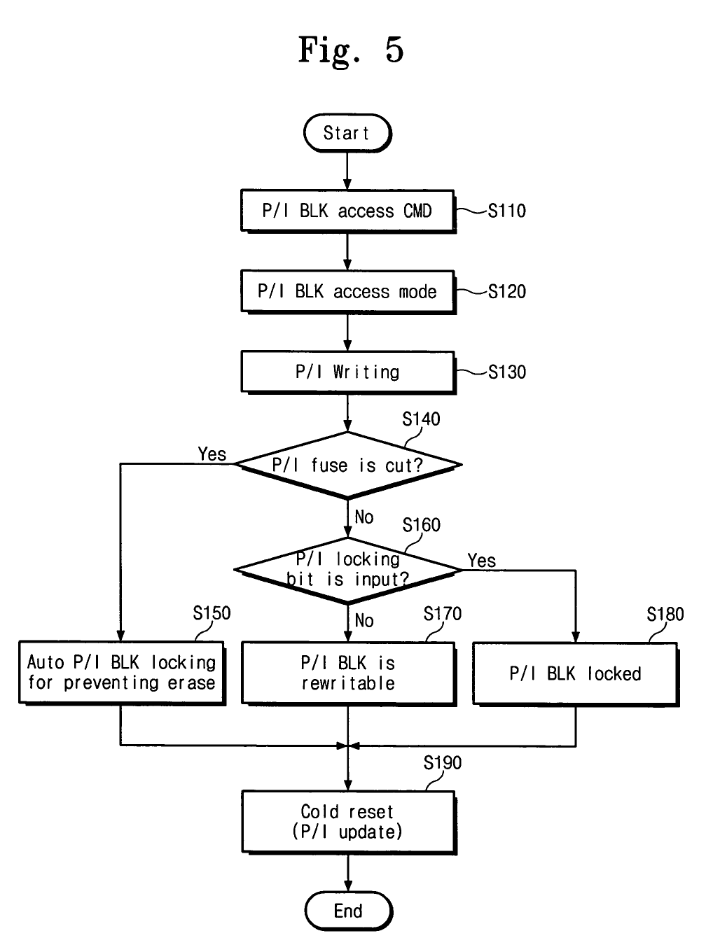

FIG. 5 illustrates a flowchart of a process of programming the locking-bit 222 in the flash memory device 200 of FIG. 3 according to an embodiment. Referring to FIGS. 3, 4, and 5, in operation S110, an external control signal PIctl is delivered to the flash memory device 200 to permit an access of a partition information block. In operation S120, the control logic 250 may start a partition information access mode in response to the external control signal PIctl.

In operation S130, based on the block address BA representing the partition information block 220 and the data input from outside, the main control unit 254 may control the program controller 256. Since the partition information block 220 is a single-bit memory block, the single-bit program controller 2564 operates. The single-bit program controller 2564 may control the read/write circuit 230 to allow the data from outside to be programmed in the partition information block 220.

In operation S140, the main control unit 254 may determine a state of the partition information fuse 253. If the partition information fuse 253 is cut off, the flow may proceed to operation S150. If the partition information fuse 253 is in a short state, the flow may proceed to operation S160.

In operation S150, the main control unit 254 may automatically program the locking-bit 220. For example, the main control unit 254 may control the single-bit program controller 2564. The single-bit program controller 2564 may control the read/write circuit 230 in response to the main control unit 254 to program 14^{th} and 15^{th} bits in a first word of a first sector in the partition information block 220 with ‘00’. Because the locking-bit 222 is programmed, the partition information block 220 is not programmed or erased during general program and erase operations. Additionally, because the partition information fuse 253 is cut off, the partition information block 220 is not erased in the partition information access mode. Thereafter, the flow may proceed to operation S190.

In operation S160, the control logic 250 determines whether data is input to program the locking-bit 222 or not. If the data is input to program the locking-bit 222, the flow may proceed to operation S180. If the data is not input to program the locking-bit 222, the flow may proceed to operation S170.

In operation S170, because the data is not input to program the locking-bit 222, the locking-bit 222 is not programmed. Accordingly, the partition information block 220 may be programmed or erased during general program and erase operations.

In operation S180, because the data is input to program the locking-bit 222, the locking-bit 222 is programmed. Accordingly, the partition information block 220 is not programmed or erased during the general program and erase operations. However, since the partition information fuse 253 is in a short state, the partition information block 220 may be programmed or erased in a partition information access mode.

In operation S190, the flash memory device 200 is cold reset, i.e., all power is stopped and then supplied again. In a power-on-reset state, the main control unit 254 may load the partition information PI stored in the partition information block 220 into the partition information register 252. This process may be done by updating the modified partition information PI in the partition information register 252 without cold reset by the main control unit 254.

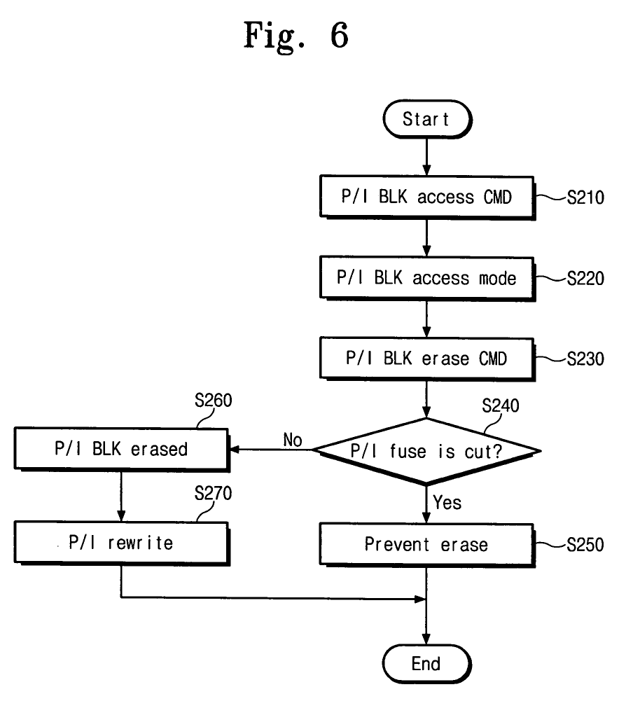

FIG. 6 illustrates a flowchart of performing of an erase operation on the partition information block 220 in the flash memory device 200 of FIG. 3 according to an embodiment. Referring to FIGS. 3, 4, and 6, in operation S210, the external control signal PIctl is delivered. In operation S220, the control logic 250 may start a partition information access mode in response to the external control signal PIctl. Once an erase command of the partition information block 220 is delivered in operation S230, the main control unit 254 may determine a state of the partition information fuse 253 in operation S240. If the partition information fuse is in a short state, the flow may proceed to operation S260. If the partition information fuse is cut off, the flow may proceed to operation S250.

In operation S250, because the partition information fuse 253 is cut off, the control logic 250 may prevent the partition information block 220 from being erased. In operation S260, because the partition information fuse 253 is in a short stare, the control logic 250 may perform an erase operation on the partition information block 220. Because the partition information PI is erased, the partition information PI may be rewritten in operation S270.

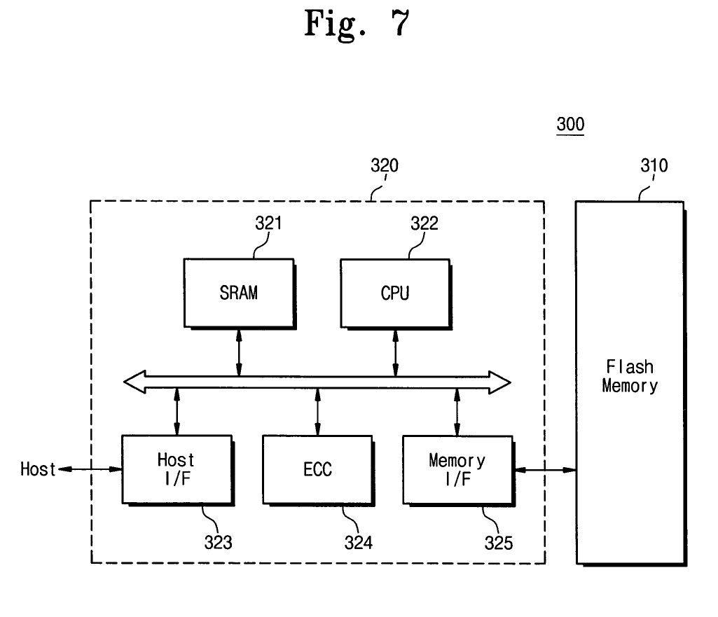

FIG. 7 illustrates a block diagram of a memory card 300 including a flash memory device 310 according to an embodiment of the present invention. Referring to FIG. 7, the memory card 300 for supporting a high storage capacity may include the flash memory device 310 of the present invention. The memory card 300 may include a memory controller 320 for controlling general data exchange between a host and the flash memory device 310.

The memory controller 320 may include a SRAM 321, a central processing unit (CPU) 322, a host interface 323, an error correction code (ECC) block 324, a memory interface 325, and a bus for electrically connected these elements. The SRAM 321 may be used as an operating memory of the CPU 322. The host interface 323 may include a data exchange protocol of a host connected to the memory card 300. The ECC block 324 may detect and correct an error in data read from the flash memory device 310. The memory interface 325 may interface with the flash memory 310. The CPU 322 may perform general control operations for data exchange of the memory controller 320. Although not illustrated in the drawings, it is apparent to those skilled in the art that the memory system 300 may further include a ROM (not shown) for storing code data to interface with a host.

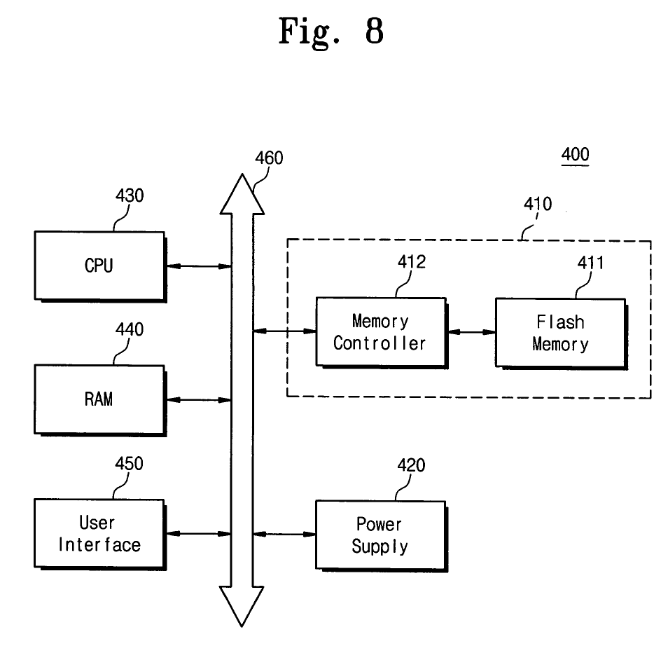

FIG. 8 illustrates a block diagram of a memory system 400 with a flash memory device 411 according to an embodiment of the present invention. Referring to FIG. 8, the memory system 400 may include a memory controller 412 and the flash memory device 411. The flash memory system 400 may include a power supply 420, a CPU 430, a RAM 440, and a user interface 450, which may be electrically connected through a system bus 460. The flash memory device 411 may store data through the memory controller 412, which are provided through the user interface 450 or processed by the CPU 430.

If the flash memory system 410 is mounted as a solid state disk/driver (SSD), a booting speed of the system 400 will be drastically improved. Although not illustrated in the drawings, it is apparent to those skilled in the art that the system of the present invention may further include an application chipset, a camera image processor (CIS), a mobile DRAM, etc.

According to the above embodiments, the partition information fuse is formed inside the control logic. However, it may be understood to those skilled in the art that the partition information fuse may be placed outside the control logic. For example, the partition information fuse may be disposed in a fuse unit where various kinds of fuses used in the flash memory device are located.

According to the above embodiments, the multi-bit and single-bit program controllers constitute the program controller, and the multi-bit and single-bit read controllers constitute the read controller. However, it may be understood to those skilled in the art that the multi-bit program controller and the multi-bit read controller may constitute the multi-bit controller, and the single-bit program controller and the single-bit read controller constitute the single-bit controller.

As described above, the flash memory device of embodiments may prevent the partition information block from being programmed or erased during a program or erase operation of the memory cell array by using the locking-bit and also may prevent the partition information block from being erased in the partition information block access mode by using the partition information fuse. Moreover, the flash memory device of embodiments may provide a mode in which a user directly programs the locking-bit and a mode in which the locking-bit is automatically programmed.

According to embodiments, the flash memory device may prevent a partition information block from being programmed or erased during a program or erase operation of a memory cell array. Additionally, a mode of accessing the partition information block may prevent the partition information block from being erased. Furthermore, the flash memory device may provide a mode in which a user directly programs a locking-bit and a mode in which a locking-bit is automatically programmed. Therefore, reliability of partition information, which indicates the boundary between a multi-bit region and a single-bit region, may be improved and user's convenience may be increased by protecting partition information.

Exemplary embodiments of the present invention have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A flash memory device, comprising:
a memory cell array including a plurality of memory blocks and a partition information block, the partition information block being configured to store partition information that indicates a boundary between multi-bit memory blocks and single-bit memory blocks among the memory blocks;
a control logic configured to determine whether a memory block that a block address from the outside indicates has a multi-bit form or a single-bit form based on the partition information and to control program and read operations in a multi-bit form or a single-bit form based on a determination result; and
a fuse connected to the control logic,
wherein the control logic is configured to automatically program data in the partition information block according to whether the fuse is cut or not, the data being used to prevent the partition information block from being programmed or erased.

2. The flash memory device as claimed in claim 1, wherein the control logic is configured to allow the partition information block to be programmable and erasable in response to an external control signal.

3. The flash memory device as claimed in claim 2, wherein the control logic is configured to prevent the partition information block from being erased according to whether the fuse is cut or not.

4. The flash memory device as claimed in claim 1, wherein the control logic comprises a multi-bit program controller and a single-bit program controller.

5. The flash memory device as claimed in claim 4, wherein the control logic further comprises a multi-bit read controller and a single-bit read controller.

6. The flash memory device as claimed in claim 1, wherein the control logic comprises a register storing the partition information.

7. The flash memory device as claimed in claim 6, wherein the partition information is loaded into the register after the partition information block is programmed.

8. The flash memory device as claimed in claim 1, wherein the control logic is configured to cold reset the flash memory device after the partition information block is programmed.

9. The flash memory device as claimed in claim 1, wherein the partition information block has the same structure as the memory block.

10. The flash memory device as claimed in claim 1, wherein the partition information block is a single-bit memory block.

11. The flash memory device as claimed in claim 10, wherein continuously arranged memory blocks adjacent to the partition information block are single-bit memory blocks.

12. The flash memory device as claimed in claim 1, wherein the fuse is disposed in the control logic.

13. A method of programming a flash memory device, the method comprising:
programming partition information in a partition information block, the partition information indicating a boundary between multi-bit memory blocks and single-bit memory blocks among the memory blocks; and
automatically programming data in the partition information block according to whether a fuse is cut or not, the data being used for preventing the partition information block from being programmed or erased.

14. The method as claimed in claim 13, wherein programming is performed in response to an external control signal.

15. The method as claimed in claim 14, wherein erasing of the partition information block is prevented according to whether the fuse is cut or not.

16. The method as claimed in claim 14, wherein automatically programming of the data is selectively performed according to whether the fuse is cut or not.

17. The method in claim 13, further comprising cold resetting the flash memory device after programming partition information in the partition information block.

18. The method as claimed in claim 13, further comprising loading the partition information into a register after programming the partition information.

19. A memory system, comprising:
a flash memory device; and
a memory controller controlling the flash memory device,
wherein the flash memory device includes:
a memory cell array including a plurality of memory blocks and a partition information block, the partition information block being configured to store partition information that indicates a boundary between multi-bit memory blocks and single-bit memory blocks among the memory blocks;
a control logic configured to determine whether a memory block that a block address from the outside indicates has a multi-bit form or a single-bit form based on the partition information and to control program and read operations in a multi-bit form or a single-bit form based on a determination result; and
a fuse connected to the control logic,
wherein the control logic is configured to automatically program data in the partition information block according to whether the fuse is cut or not, the data being used for preventing the partition information block from being programmed or erased.

20. The memory system as claimed in claim 19, wherein the flash memory device and the memory controller constitute a memory card.
